(19) United States
(12) Patent Application Publication
(10) Pub. No.: US 2022/0132969 A1
(43) Pub. Date: May 5, 2022

(54) ACCIDENT PREVENTION SYSTEM AND METHODS THEREFORE

(71) Applicant: HÖVDING SVERIGE AB, MALMÖ (SE)

(72) Inventor: Heino WENDELRUP, Bjärred (SE)

(21) Appl. No.: 17/433,990

(22) PCT Filed: Feb. 28, 2020
(86) PCT No.: PCT/SE2020/050226

§ 371 Date: Aug. 25, 2021

(30) Foreign Application Priority Data
Mar. 1, 2019 (SE) 1950269-9

(51) Int. Cl. A42B 3/04; G08B 21/02

(52) U.S. Cl. CPC A42B 3/046; G08B 21/02; A42B 3/0486

(57) ABSTRACT

A method for alerting a user of a wearable airbag system. The method includes the steps of ensuring that the airbag system is active, checking the current location of the airbag system, calling a server storing a plurality of locations, each location being associated with an increased risk for an accident, and if the current location of the airbag system is close to a stored location, further performing a step of alerting the user.

### TECHNICAL FIELD

The present invention relates to an accident prevention system and methods therefore. More particularly, the present invention relates to an accident prevention system, a method of maintaining an accident prevention system, a method for logging locations while biking, and a method for alerting a user.

### BACKGROUND

There are many dangers while biking in an urban environment. Busy intersections, potholes, or oil spills or other areas of low friction are common examples of dangerous occurrences. The Applicant has previously developed a wearable airbag system for protecting a user should an accident occur; see for instance EP1947966B1; however, a need has been discovered for preventive measures to further reduce dangers while biking. In the prior art, there currently exist systems for notifying car drivers about a nearby accident; see for instance JPH0664565A; however, for multiple reasons these types of systems are unsuitable for biking.

An object of the present invention is therefore to provide an accident prevention system suitable for biking, or when riding scooters, e.g. electric scooters made available by LIME.

### SUMMARY

According to a first aspect of the invention, the above and other objects of the invention are achieved, in full or in part, by a method for alerting a user of a wearable airbag system. The method comprises i) ensuring that the airbag system is active; ii) checking the current location of the airbag system; iii) calling a server storing a plurality of locations, each location being associated with an increased risk for an accident; and iv) if the current location of the airbag system is close to a stored location, further performing a step of alerting the user.

Alerting the user may be performed by means of the wearable airbag system.

The method may further comprise a step of braking a vehicle of the user, such as a bicycle. Preferably, such automatic braking may be performed after alerting the user, or as a means for alerting the user.

According to a second aspect, a method for logging locations while biking by means of a wearable airbag system comprising an accident detection system, is provided. The method comprises i) ensuring that the airbag system is active; and ii) measuring movements while biking by means of the accident detection system; wherein if the measured movements are indicative of an increased risk for an accident, further performing iii) triggering a communication unit; and iv) transmitting a location of the airbag system to a server by means of the communication unit.

The method may further comprise a step of activating the airbag system.

The triggering step and the transmitting step may be performed after the activating step.

The method may further comprise a step of de-activating the airbag system.

The triggering step and the transmitting step may be performed after the de-activating step.

The method may further comprise a step of deploying the airbag system if the measured movements are indicative of the occurrence of an accident.

The transmitted location may be the location of the airbag system when measuring the movements indicative of an increased risk for an accident.

According to a third aspect, a method of maintaining an accident prevention system is provided. The method comprises the steps of the method for logging locations according to the second aspect and the steps of the method for alerting a user according to the first aspect.

According to a fourth aspect, an accident prevention system is provided. The accident prevention system comprises a wearable airbag system comprising an accident detection system configured to measure movements indicative of an increased risk for an accident; and a communication unit configured to transmit a location of the airbag system to a server.

The accident detection system may comprise at least one sensor such as a gyroscope and/or an accelerometer.

The communication unit may comprise a global positioning system and wireless communication means.

The communication unit may be comprised in the airbag system, or the communication unit may be a remote unit, such as a mobile phone.

The airbag system and the communication unit may be operatively connected to each other by means of Bluetooth.

Other objectives, features and advantages of the present invention will appear from the following detailed disclosure, from the attached claims, as well as from the drawings. It is noted that the invention relates to all possible combinations of features.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise.

### BRIEF DESCRIPTION OF THE DRAWINGS

By way of example, embodiments of the present invention will now be described with reference to the accompanying drawings, in which:

FIG. 1a is a schematic illustration of an accident prevention system according to an embodiment;

FIG. 1b is a schematic illustration of an accident prevention system according to an embodiment;

FIG. 2 is a schematic illustration of an accident prevention system in use according to an embodiment;

FIG. 3 shows a flowchart of a method for logging locations according to an embodiment; and

FIG. 4 shows a flowchart of a method for alerting a user according to an embodiment.

### DETAILED DESCRIPTION

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

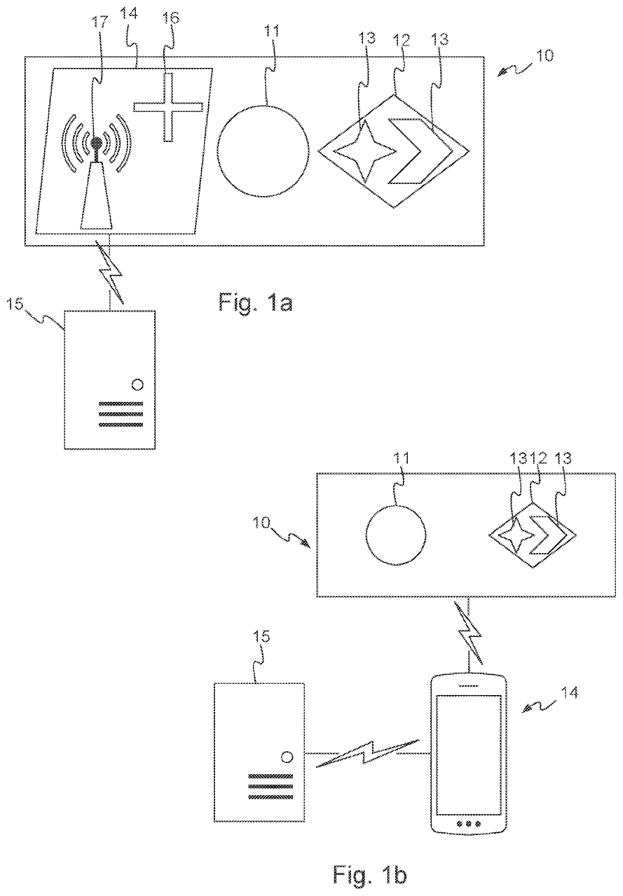

Starting in FIG. 1a, an accident prevention system is shown. The accident prevention system comprises a wearable airbag system 10. The wearable airbag system 10 is preferably arranged as a collar around a head of a user. The wearable airbag system 10 comprises an airbag 11 configured to deploy when an accident is detected. The wearable airbag system 10 further comprises an accident detection system 12 configured to measure movements of the user/collar, and to determine if the measured movements are indicative of an accident. The wearable airbag system 10 further comprises a communication unit 14 configured to transmit, preferably wirelessly, a location of the wearable airbag system 10 to a server 15.

The accident detection system 12 comprises at least one sensor 13. The sensor(s) 13 preferably detect motion; optionally, tilt and/or impact may also be measured. Sensor data may then be analyzed by e.g. a control unit to determine if an accident is occurring. This detection may e.g. use previously established threshold values or machine learning in order to accurately determine if there is an accident or not. In the embodiment shown in FIGS. 1a-b, the sensors 13 are a gyroscope 13 and an accelerometer 13.

The communication unit 14 comprises a positioning unit 16, such as a global positioning system (GPS), or any other means (such as triangular systems) for determining the current position of the wearable airbag system and internet communication means 17. The positioning module 16 is e.g. in communication with a GPS satellite in order to receive real-time location data of the wearable airbag system 10, i.e. the user. The internet communication means 17 may be wired or wireless and is preferably a wireless antenna such as a Wi-Fi antenna. Other examples of communication means 17 include cellular data means such as 3G, 4G, 5G, etc.

In a preferred embodiment, the communication unit 14 is programmed to transmit the current location of the wearable airbag system 10 when the accident detection system 12 has determined that there is an increased risk for an accident.

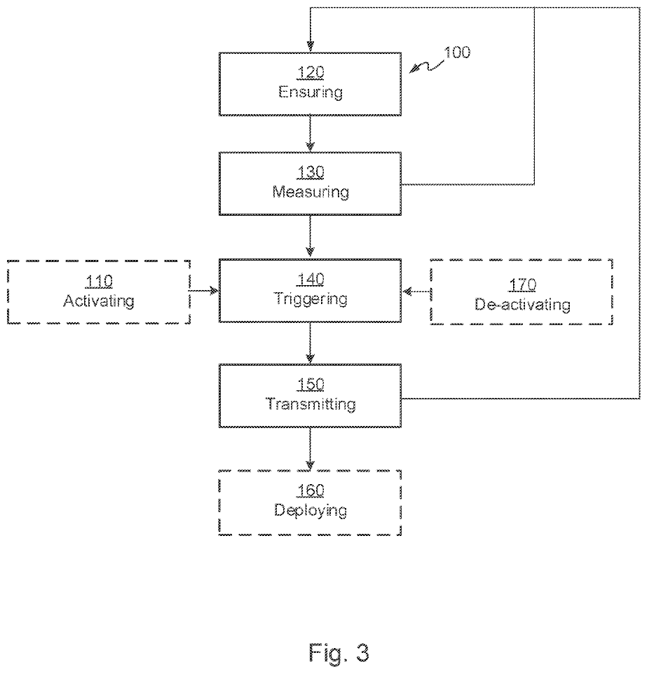

The server 15 may be remote or a local memory and is preferably a remote memory 15. The server 15 may process the location information in any number of ways, one example being an indexed list that comprises a location, a time, sensor data and some sort of classification for the type of accident which has been determined to be of increased risk (e.g. slippery road). The server data will be updated according to a method, indicated by reference numeral 100 in FIG. 3, for logging locations.

The server 15 may further comprise user-submitted information regarding a specific accident or accident location. This may further be used to determine if the danger is permanent, time dependent or has been fixed.

FIG. 1b shows an accident prevention system according to an alternate embodiment. The embodiment is similar to what has been described with respect to FIG. 1a, however the communication unit 14 is in this embodiment an external device, such as a mobile phone of the user, which is capable of communicating with the wearable airbag system 10.

The wearable airbag system 10 comprises an airbag 11 configured to deploy when an accident is detected. The wearable airbag system 10 further comprises an accident detection system 12 configured to measure movements when biking, and to determine if the measured movements are indicative of an increased risk for an accident.

The wearable airbag system 10 further comprises a communication unit 14 configured to transmit 150 a location of the wearable airbag system 10 to a server 15. The communication unit 14 is a remote unit separate from the wearable airbag system 10. In this embodiment, the communication unit 14 is a mobile phone of the user. The remote communication unit 14 comprises a positioning module 16, such as a GPS, and internet communication means 17.

The communication unit 14 further comprises an app for controlling the communication between the communication unit 14 and the airbag system 10 and the communication unit 14 and the server 15. The app may also be used to input user-submitted information regarding a specific accident or accident location. The app may further be used to access information about a specific accident location to find out more about how to avoid it or to see if it has been resolved.

The communication unit 14 and the airbag system 10 are operatively connected to each other by means of wireless communication, such as Bluetooth. Each of the communication unit 14 and the airbag system 10 thereby comprises a Bluetooth antenna.

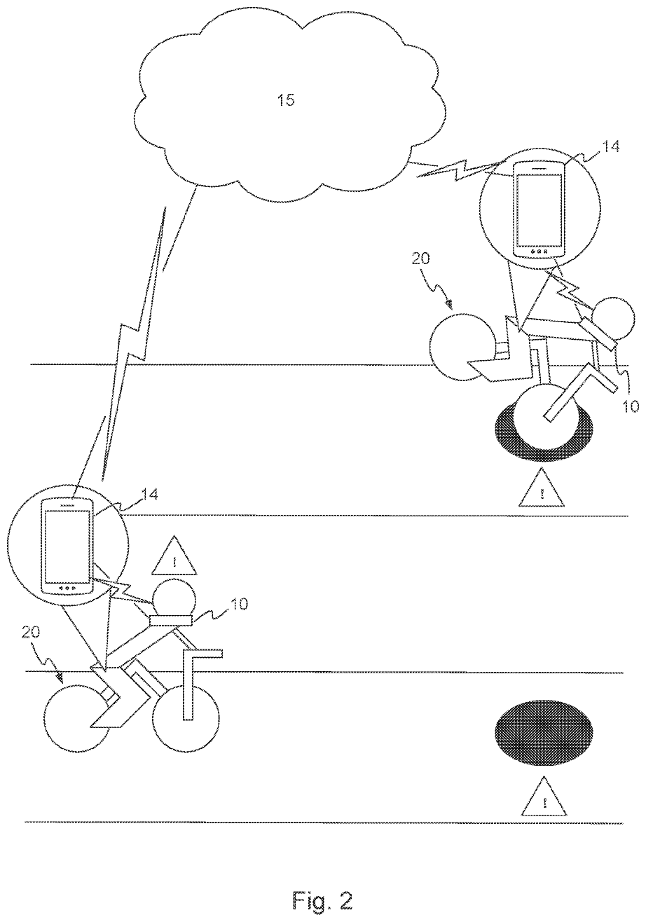

FIG. 2 shows the accident prevention system in use. The upper section shows a user on a bicycle 20, riding over an area causing an increased risk for an accident. As the accident detection system 12 determines that there is an increased risk for an accident, the accident detection system 12 triggers the communication unit 14. The communication unit 14 transmits the current location of the user to a server 15.

The airbag system 10 may further deploy the airbag 11 to protect the user, if the accident detection system 12 determines that an accident is really occurring.

However, the accident detection system 12 is preferably programmed to analyze the measured sensor data and to determine one of three possible situations: i) no accident, i.e. normal bicycling, ii) increased risk for an accident, or iii) an accident. Inflation of the wearable airbag system 10, i.e. the helmet is only performed if an accident is occurring, i.e. for situation iii). Uploading the position of the wearable airbag system 10 to the server 15 should preferably be performed each time an increased risk for an accident is determined, i.e. situation ii).

Thereby, the mere possibility for an accident to occur may induce the logging of a dangerous location even if no deployment is deemed to be necessary.

The lower section shows the same location at a later time while another user on a bicycle 20 is closing in on the dangerous location. The airbag system 10 is active, and the communication unit 14 is therefore configured to continuously check the location of the user and call, or referencing the server 15 if accidents have happened nearby. As the user is close to a location where an accident has happened, the communication unit 14 makes the airbag system 10 alert the user, e.g. using light or sound. The user may then avoid an accident by e.g. slowing down and acting carefully.

FIG. 3 is a flowchart of a method 100 for logging locations while biking by means of a wearable airbag system 10 comprising an accident detection system 12 as described previously. The method 100 comprises a number of steps 110-170. These steps may be performed in any order, some may be skipped and others repeated and different steps may be performed by different units. The steps may be performed randomly, periodically or a sequence of steps may be started by a user or automatically.

The ensuring step 120 comprises ensuring that the airbag system 10 is active. This is preferably performed before the measuring step 130. This step 120 may be implemented in that the accident detection system 12 is only powered when the airbag system 10 is active. The effect of the ensuring step 120 is that there is no need to detect accidents if the user is not biking.

The measuring step 130 comprises measuring movements during biking, and determining if the measured sensor data is indicative of an increased risk for an accident. This step 130 is preferably performed by the accident detection system 12. The measurements may e.g. comprise data from one or more sensor 13. Based on previously established values, a first and optionally a second threshold value for measurements from the one or more sensor 13 exist. If the three situations i)-iii) are utilized, the measured sensor data can be transformed to a scalar. A first threshold is used to determine that there is an increased risk for an accident, while a second (and higher) threshold is used to determine that there is an accident occurring.

The ensuring step 120 and the measuring step 130 are repeated until at least the first threshold value is reached during the measuring step 130. This repetition may e.g. be periodic every second. If the first threshold value is reached, the triggering step 140 is performed. If the second threshold value is reached, the deploying step 160 is performed as well. The second threshold value preferably corresponds to an accident where a user is in danger, such as a fall, requiring inflation of the airbag.

The triggering step 140 comprises triggering a communication unit 14. This may comprise the accident detection system 12 sending a Bluetooth signal or wired signal to the communication unit 14.

The transmitting step 150 comprises transmitting the location of the airbag system 10 to a server 15. This step 150 is preferably performed by a communication unit 14. The communication unit 14 comprises a the positioning module, such as the GPS, and it is assumed that the communication unit 14, the airbag system 10 and the location of the accident are in close proximity. The transmitting step 150 may further comprise transmitting information about the accident such as the time of the accident or how fast the bike was going.

In order to adapt to a fast changing urban environment, the server 15 may allow or require more information about an accident, such as the time of day, the weather and/or user input regarding the cause. A user may then further be allowed to report that a source of accidents has been changed or resolved, such as ice melting or a new traffic light.

The deploying step 160 comprises deploying the airbag system 10 if the measured 130 sudden movements are above the second threshold value. The airbag 11 of the airbag system 10 is deployed in order to protect the user.

The activating step 110 comprises activating the airbag system 10. This step 110 is preferably performed as soon as the user starts biking. After the activating step 110, the triggering step 140 and the transmitting step 150 are preferably performed. This is advantageous in that it allows the server 15 to have information regarding where bike rides are started. The transmitting step 150, when activated in this fashion, may further comprise transmitting 150 information that the location corresponds to where a bike ride has started.

The de-activating step 170 comprises de-activating the airbag system 10. This step 170 is preferably performed as soon as the user stops biking. After the de-activating step 170, the triggering step 140 and the transmitting step 150 are preferably performed. This is advantageous in that it allows the server 15 to have information regarding where bike rides are ended. The transmitting step 150, when activated in this fashion, may further comprise transmitting 150 information that the location corresponds to where a bike ride has ended.

Information regarding where bike rides are started and ended may be used to recommend safe routes or find common routes that may need improvements such as an extra bike lane.

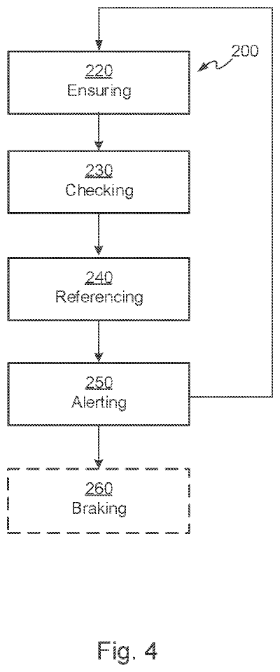

FIG. 4 shows a flowchart of a method 200 for alerting the user of the wearable airbag system 10 as described previously. The method 200 comprises a number of steps 220-260. These steps may be performed in any order, some may be skipped and others repeated and different steps may be performed by different units. The steps may be performed randomly, periodically or a sequence of steps may be started by a user or automatically.

The ensuring steps 220 comprises ensuring that the airbag system 10 is active. This is preferably performed before the checking step 230. The effect of the ensuring step 220 is that there is no need to check for dangerous locations if the user is not biking.

The checking step 230 comprises checking the location of the airbag system 10. This step 230 may be performed using a GPS of a communication unit 14 as previously described.

The referencing step 240 comprises referencing a server 15 comprising locations where accidents have happened. This step 240 may be performed using internet communication means of a communication unit 14. This communication unit 14 is not necessarily the same communication unit 14 as the one that performs the checking step 230.

The server 15 may be configured to selectively allow access only to the most relevant locations or the communication unit 14 may be configured to only reference 240 the most relevant locations. The most relevant locations may be determined e.g. by proximity to the airbag system 10, however if more information is available regarding the locations, this may be used to determine relevance as well. For example, if all accidents at a location happen during rush hour, this location may have an increased relevance during rush hour and a decreased relevance outside of rush hour. Similarly, if all accidents at a location have happened after a sudden drop in temperature and stop after the temperature rises, this may be the result of ice that is only relevant during winter.

The alerting step 250 comprises alerting the user. This may involve a loud noise or a bright light and may be performed e.g. either by the airbag system 10 or the communication unit 14. This step 250 is preferably only performed if the location of the airbag system 10 is close to a location where accidents have happened. The location may be determined to be close if either it is within a predetermined distance of the user or if it would take the user a predefined time to get there based on their speed. The speed and location of the user may be measured using sensors 13 comprised in an accident detection system 12 comprised in the airbag system 10.

The braking step 260 comprises braking a vehicle of the user. The vehicle is preferably a bicycle. The brake system of the vehicle may be operatively connected to the airbag system 10, the communication unit 14 or both. By connecting the brake system in this way, the braking step 260 may brake the vehicle faster than the user can react, which may prevent an accident.

The method 100 for logging locations while biking by means of a wearable airbag system 10 and the method 200 for alerting a user of a wearable airbag system 10 may be regarded as a data sending method 100 and a corresponding data receiving method 200 of the same system. Combined, they form a method of maintaining an accident prevention system. The server 15 that the method 200 for alerting references 230 is supplied with data according to the method 100 for logging locations. The same airbag system 10 may be configured to perform the steps of both methods 100, 200, at different times or simultaneously.

While the embodiments discussed in this description have mainly focused on biking, the teachings herein are also applicable to other vehicles, such as scooters, motorcycles and cars; or for pedestrians wearing the airbag system 10. However, different situations may be dangerous depending on the vehicle or lack thereof. Thusly, the first and optionally the second threshold values may need to be adjusted, different sensors 13 may be more useful and additional information may be more or less relevant. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A method for alerting a user of a wearable airbag system, the method comprising steps of:
ensuring that the airbag system is active;
checking a current location of the airbag system;
calling a server storing a plurality of locations, each location being associated with an increased risk for an accident; and
if the current location of the airbag system is close to a stored location, further performing a step of alerting the user.

2. The method according to claim 1, wherein alerting the user is performed by means of the wearable airbag system.

3. The method according to claim 1, further comprising a step of braking a vehicle of the user.

4. A method for logging locations while biking by means of a wearable airbag system comprising an accident detection system, the method comprising steps of:
ensuring that the airbag system is active; and
measuring movements while biking by means of the accident detection system;
wherein if the measured movements are indicative of an increased risk for an accident, further performing the steps of:
triggering a communication unit; and
transmitting a location of the airbag system to a server by means of the communication unit.

5. The method according to claim 4, further comprising a step of activating the airbag system.

6. The method according to claim 5, wherein the triggering step and the transmitting step are performed after the activating step.

7. The method according to claim 5, further comprising a step of de-activating the airbag system.

8. The method according to claim 7, wherein the triggering step and the transmitting step are performed after the de-activating step.

9. The method according to claim 4, further comprising a step of deploying the airbag system if the measured movements are indicative of an occurrence of an accident.

10. The method according to claim 4, wherein the transmitted location is the location of the airbag system when measuring the movements indicative of an increased risk for an accident.

11. A method of maintaining an accident prevention system comprising the steps of the method for logging locations according to claim 4, and further comprising the steps of:
calling the server storing a plurality of locations, each location being associated with an increased risk for an accident; and
if a current location of the airbag system is close to a stored location, further performing a step of alerting a user.

12. An accident prevention system comprising:
a wearable airbag system comprising an accident detection system configured to measure movements indicative of an increased risk for an accident; and
a communication unit configured to transmit a location of the airbag system to a server.

13. The system according to claim 12, wherein the accident detection system comprises at least one sensor such as a gyroscope and/or an accelerometer.

14. The system according to claim 12, wherein the communication unit comprises a global positioning system and wireless communication means.

15. The system according to claim 12, wherein the communication unit is comprised in the airbag system.

16. The system according to claim 12, wherein the communication unit is a remote unit.

17. The system according to claim 16, wherein the airbag system and the communication unit are operatively connected to each other by means of Bluetooth.

18. The system according to claim 16, wherein the remote unit is a mobile phone.

19. The method according to claim 3, wherein the vehicle is a bicycle.
